(19) United States
(12) Patent Application Publication
(10) Pub. No.: US 2014/0178788 A1
(43) Pub. Date: Jun. 26, 2014

(54) CATALYST SLURRY FOR FUEL CELL, ELECTRODE PREPARED USING THE SAME, MEMBRANE-ELECTRODE ASSEMBLY INCLUDING THE ELECTRODE, FUEL CELL INCLUDING THE MEMBRANE-ELECTRODE ASSEMBLY, AND METHOD OF PREPARING THE ELECTRODE

(71) Applicant: SAMSUNG ELECTRONICS CO., LTD., Suwon-si (KR)

(72) Inventors: Jin-su HA, Cheonan-si (KR); Suk-gi HONG, Seongnam-si (KR); Jung-ock PARK, Yongin-si (KR); Yoon-hoi LEE, Hwaseong-si (KR); Joon-hee KIM, Seoul (KR)

(73) Assignee: SAMSUNG ELECTRONICS CO., LTD., Suwon-si (KR)

(21) Appl. No.: 13/967,505

(22) Filed: Aug. 15, 2013

(30) Foreign Application Priority Data
Dec. 24, 2012 (KR) 10-2012-0152438

(51) Int. Cl. H01M 4/86; H01M 4/92

(52) U.S. Cl. CPC H01M 4/8663; H01M 4/921
USPC 429/480; 429/523; 429/535; 502/100; 502/172; 502/208

(57) ABSTRACT

A catalyst slurry for a fuel cell, an electrode manufactured using the catalyst slurry, a membrane-electrode assembly including the electrode, a fuel cell including the membrane-electrode assembly, and a method of manufacturing the electrode are provided. The catalyst slurry includes a catalyst material, an acid component, a binder, and a solvent component having a viscosity of at least about 20 cps at about 20° C.

### CROSS-REFERENCE TO RELATED APPLICATIONS

This application claims priority to Korean Patent Application No. 10-2012-0152438, filed on Dec. 24, 2012, and all the benefits accruing therefrom under 35 U.S.C. §119, the contents of which in their entirety are herein incorporated by reference.

### BACKGROUND

1. Field

The present application relates to a catalyst slurry for a fuel cell, an electrode prepared using the catalyst slurry, a membrane-electrode assembly including the electrode, a fuel cell including the membrane-electrode assembly, and a method of preparing the electrode. More particularly, the present application relates to an electrode-membrane assembly including an electrode having a uniform composition and improved performance, the electrode being manufactured using a catalyst slurry with good storage stability. The application also relates to a fuel cell including the membrane-electrode assembly, and a method of manufacturing the electrode in shorter process time.

2. Description of the Related Art

According to the types of electrolyte used, fuel cells, drawing attention as alternative energy sources, may be classified as polymer electrolyte membrane fuel cells (PEMFC), phosphoric acid fuel cells (PAFC), molten carbonate fuel cells (MCFC), or solid oxide fuel cells (SOFC).

In general, electrodes for a fuel cell are manufactured using a catalyst slurry. The catalyst slurry may be prepared by mixing a catalyst material with a solvent component. If necessary, a binder or an acid component can be added.

However, when the catalyst slurry for a fuel cell is stored for a long time, the catalyst slurry may have a non-uniform composition due to the precipitation of the catalyst material. Accordingly, an electrode manufactured using such a catalyst slurry may not have uniformity and high performance.

For example, for high-temperature polymer electrolyte membrane fuel cells (HT-PEMFCs) operating in non-humidified conditions at high temperatures of about 100° C. or higher, for example, at 120 to about 180° C., mixing an acid component as an ionomer with a catalyst material, a binder and a solvent component is important in preparing the catalyst slurry.

In general, a HT-PEMFC may be manufactured via post-impregnation with an acid component as an ionomer. That is, an electrode is first formed by coating a catalyst slurry including a catalyst material and a solvent component, or a catalyst material, a binder and a solvent on a gas diffusion layer (GDL), then the formed electrode is impregnated with an acid component serving as an ionomer.

An electrode for a HT-PEMFC may also be manufactured by mixing an acid component as an ionomer with the slurry. This method does not involve post-impregnation as described above, and thus may reduce processing costs. This method also allows the acid component to be more uniformly distributed in the electrode, and thus may improve performance of the electrode.

However, when the catalyst slurry is stored for a long time, due to reduced stability of the catalyst slurry, the acid component as an ionomer may not be uniformly distributed. Furthermore, the acid component may react with a solvent component in the catalyst slurry, and thus produce byproducts. Accordingly, the catalyst slurry pre-impregnated with an acid component can only be used in very limited conditions. Therefore, there is a need for improvements in this regard.

### SUMMARY

Provided is a catalyst slurry with improved storage stability.

Provided is an electrode formed using the catalyst slurry with uniform composition and improved performance.

Provided is a membrane-electrode assembly including the electrode manufactured using the catalyst slurry, wherein the membrane-electrode has improved cell performance.

Provided is a fuel cell including the membrane-electrode assembly.

Provided is a method of manufacturing an electrode with uniform composition and improved performance in shorter process time by using the catalyst slurry.

Additional aspects will be set forth in part in the description which follows and, in part, will be apparent from the description, or may be learned by practice of the presented embodiments.

According to an aspect of the present disclosure, a catalyst slurry for a fuel cell includes a catalyst material, an acid component, a binder, and a solvent component having a viscosity of at least about 20 cps at about 20° C.

The solvent component may be at least one selected from diethylene glycol, propylene glycol, dipropylene glycol, 1,3-butylene glycol, and dihydroterpineol).

The binder may be at least one selected from a polybenzoxazine, a fluorinated polymer, a benzimidazole polymer, a polyimide, a polyetherimide, a polyphenylenesulfide, a polysulfone, a polyethersulfone, a polyetherketone, a polyether-etherketone, and a polyphenylquinoxaline.

The acid component may be at least one selected from phosphoric acid, polyphosphoric acid, phosphorous acid, sulfuric acid, nitric acid, perchloric acid, phosphonic acid, and trifluoromethane sulfonic acid.

The catalyst material may include a support and a catalytic metal loaded on the support.

A weight ratio of the catalyst metal to the solvent in the catalyst slurry may be from about 1:3 to about 1:25.

A weight ratio of the catalyst metal to the acid component in the catalyst slurry may be from about 1:0.1 to about 1:10.

According to another aspect of the present disclosure, an electrode for a fuel cell includes:

a gas diffusion layer having a microporous layer (MPL) disposed on an electrode support; and

a catalyst layer disposed on the gas diffusion layer, the catalyst layer being formed using the catalyst slurry described above.

The gas diffusion layer may be hydrophobically treated.

The catalyst layer may be formed by coating the catalyst slurry on the gas diffusion layer at a contact angle of about 143° or less.

A volume of pores having a pore diameter of about 1 μm to about 5 μm in the electrode may be about 0.15 mL/g or greater.

According to another aspect of the present disclosure, a membrane-electrode assembly for a fuel cell includes:

a cathode;

an anode; and

an electrolyte membrane disposed between the cathode and the anode,

wherein at least one of the cathode and the anode is the electrode described above.

The electrode may have a proton-area specific resistance of about 0.23 ohm·cm² or less.

According to another aspect of the present disclosure, a fuel cell includes the membrane-electrode assembly described above.

According to another aspect of the present disclosure, a method of manufacturing an electrode for a fuel cell includes:

preparing a catalyst slurry comprising a catalyst material, an acid component, a binder, and a solvent component having a viscosity of at least about 20 cps at about 20° C.; and

coating the catalyst slurry on a gas diffusion layer having a microporous layer (MPL) and thermally treating the catalyst slurry coated gas diffusion layer to form a catalyst layer.

### BRIEF DESCRIPTION OF THE DRAWINGS

These and/or other aspects will become apparent and more readily appreciated from the following description of the embodiments, taken in conjunction with the accompanying drawings of which:

FIG. 1 is an exploded perspective view of an exemplary embodiment of a fuel cell;

FIG. 2 is a schematic cross-sectional view of a membrane-electrode assembly (MEA) of the fuel cell of FIG. 1;

FIG. 3 is a schematic cross-sectional view of an electrode of the MEA of FIG. 2;

FIG. 4 is an image illustrating measuring a contact angle of a catalyst slurry of Example 1 with respect to a surface of a gas diffusion layer by using a contact angle measuring device after dropping the catalyst slurry onto the gas diffusion layer;

FIG. 5 is a graph of interface height (percent, %) with respect to time (hour, hr) in the catalyst slurries of Example 1 and Comparative Examples 2 and 3;

FIG. 6 is a graph of specific pore volume (milliliter per gram, mL/g) with respect to pore diameter (nanometer, nm) in electrodes manufactured in Example 6 and Comparative Example 9;

FIG. 7 is a graph of voltage (volt, v) with respect to current density (milliampere per square centimeter, mA/cm²) illustrating the results of cell performance evaluation of MEAs of Example 6 and Comparative Example 9;

FIG. 8 is a graph illustrating the results of cell impedance tests of the MEAs of Example 6 and Comparative Example 9;

FIG. 9A is a flowchart of an exemplary embodiment of a method of manufacturing an MEA; and

FIG. 9B is a flowchart of a method of manufacturing of an MEA of Comparative Example 9.

### DETAILED DESCRIPTION

Reference will now be made in detail to embodiments of a catalyst slurry for a fuel cell, an electrode using the catalyst slurry, a membrane-electrode assembly including the electrode, a fuel cell including the membrane-electrode assembly, and a method of manufacturing the electrode, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. The term “or” means “and/or.” As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it may be directly on the other element or intervening elements may be present therebetween. In contrast, when an element is referred to as being “directly on” another element, there are no intervening elements present. It will be understood that, although the terms first, second, third etc. may be used herein to describe various elements, components, regions, layers and/or sections, there elements, components, regions, layers and/or sections should not be limited by these terms. These terms are only used to distinguish one element, component, region, layer or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may typically have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

An acid component in a catalyst slurry for a fuel cell may serve as an ionomer, which may continuously provide an electrode catalyst layer with an ion transfer path to improve the ionic conductivity of the electrode. Accordingly, there is a need to improve the ionomer distribution in an electrode.

In general a catalyst slurry for fuel cells use N-methyl-2-pyrrolidone (NMP) as a solvent component. However, NMP may react with an acid component, for example, phosphoric acid, to obstruct the function of ionomers. To block this reaction, an electrode may be manufactured via post-impregnation with phosphoric acid. That is, after manufacturing an electrode by coating a catalyst slurry as a mixture of a catalyst material and a solvent material, and a binder if necessary, i.e., excluding phosphoric acid, on an electrode support or a gas diffusion layer and thermally treating the resultant, the electrode may then be impregnated with phosphoric acid and dried. That is, an electrode may be manufactured using a method further including a post-impregnation with phosphoric acid after manufacturing the electrode.

However, the method including additional post-impregnation with phosphoric acid may increase process costs. Furthermore, using NMP or H₂O may deteriorate the storage stability of a catalyst slurry when stored for a long time.

According to an embodiment of the present disclosure, a catalyst slurry for a fuel cell includes a catalyst material, an acid component, a binder, and a solvent component having a viscosity of at least about 20 cps at about 20° C.

For example, the solvent component may have a viscosity of about 20 cps to about 1500 cps at about 20° C., and in some embodiments, about 20 cps to about 200 cps at about 20° C. The solvent component has increased viscosity compared to those known in the art, for example, N-methyl-2-pyrrolidone.

The catalyst slurry according to the present disclosure has improved storage stability. Using the catalyst slurry may reduce the manufacturing time and cost.

The solvent component may be at least one selected from diethylene glycol (DEG), propylene glycol (PG), dipropylene glycol (DPG), 1,3-butylene glycol, and dihydroterpineol (DHT). For example, the solvent component may be dipropylene glycol (DPG). An amount of the solvent component may be from about 50 to about 85 parts, from about 50 to about 80 parts, from about 55 to about 75 parts by weight, from about 60 to about 85 parts by weight, or from about 60 to about 80 parts by weight, by weight based on 100 parts by weight of the catalyst slurry.

The binder may be at least one selected from a polybenzoxazine, a fluorinated polymer, a benzimidazole polymer, a polyimide, a polyetherimide, a polyphenylenesulfide, a polysulfone, a polyethersulfone, a polyetherketone, a polyether-etherketone, and a polyphenylquinoxaline.

The polybenzoxazine may be, for example, a polymer prepared from a monomer represented by Formula 1.

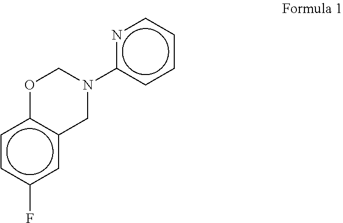

In some embodiments, the binder may be at least one selected from a fluorinated polymer such as a polyvinylidene fluoride (PVdF), a polytetrafluoroethylene (PTFE), a vinylidene fluoride-hexafluoropropylene copolymer, and a fluorine-terminated phenoxide based hyperbranched polymer (HPEF). An amount of the binder may be from about 0.5 parts to about 10 parts, from about 1 to about 8 parts, from about 2 to about 6 parts, from about 2 to about 4 parts, from about 3 to about 8 parts, or from 3 to about 7 parts by weight based on 100 parts by weight of the catalyst material. When the amount of the binder is within this range, it may be easy to form an electrode catalyst layer, and cell performance may be further improved.

The acid component may be at least one selected from phosphoric acid (H₃PO₄), polyphosphoric acid (Hₙ₊₃PₙO₃ₙ, e.g., pyrophosphoric acid (H₄P₂O₇), tripolyphosphoric acid (H₅P₃O₁₀), and tetrapolyphosphoric acid (H₆P4O₁₃)), phosphorous acid (H₃PO₃), sulfuric acid (H₂SO₄), nitric acid (HNO₃), perchloric acid (HClO₄), phosphonic acid (RPO₃H₂ wherein R is a H, Cl to C18 alkyl, C3 to C8 cycloalkyl, C4 to C18 aryl, or C7 to C30 arylalkylene group), and trifluoromethane sulfonic acid. For example, the acid component may be at least one selected from phosphoric acid, polyphosphoric acid, sulfuric acid, organic phosphonic acid, and inorganic phosphonic acid. An amount of the acid component may be from about 2 parts to about 40 parts, from about 5 parts to about 35 parts, from about 10 to about 30 parts, from about 10 to about 25 parts, from about 15 parts to about 40 parts, or from about 15 parts to about 35 parts by weight based on 100 parts by weight of the catalyst slurry.

The catalyst material may include a support and a catalytic metal loaded on the support.

The support may be at least one selected from carbon powder, carbon black, acetylene black, ketjen black, active carbon, carbon nanotubes, carbon nanofibers, carbon nanowires, carbon nanohorns, ordered nanoporous carbon, carbon aerogels, carbon cryogels, and carbon nanorings.

The catalyst metal of each of the anode and the cathode may be at least one selected from a platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), tin (Sn), titanium (Ti), chromium (Cr), and an alloy of at least two thereof.

An amount of the catalyst material may be from about 4 parts to about 15 parts by weight, and in some embodiments, from about 5 parts to 100 parts, or less than about 100 parts by weight, based on 100 parts by weight of the catalyst slurry. When the amount of the catalyst material is within these ranges, the catalyst metal may have high utilization efficiency, and the cell performance of the fuel cell may be maintained high.

In the catalyst slurry for a fuel cell, a weight ratio of the catalyst metal to the solvent may be from about 1:3 to about 1:25, and in some other embodiments, from about 1:5 to about 1:19. When the weight ratio of the catalyst metal to the solvent is within these ranges, the catalyst slurry may maintain an appropriate viscosity and a uniform composition.

In the catalyst slurry for a fuel cell, a weight ratio of the catalyst metal to the acid component in the catalyst slurry may be from about 1:0.1 to about 1:10, and in some other embodiments, from about 1:0.4 to about 1:4.3. When the weight ratio of the catalyst metal to the acid component is within these ranges, the fuel cell may have improved performance.

According to another embodiment, an electrode for a fuel cell includes: a gas diffusion layer having a microporous layer (MPL) disposed on an electrode support; and a catalyst layer disposed on the gas diffusion layer, the catalyst layer being formed using any of the catalyst slurries according to the above-described embodiments.

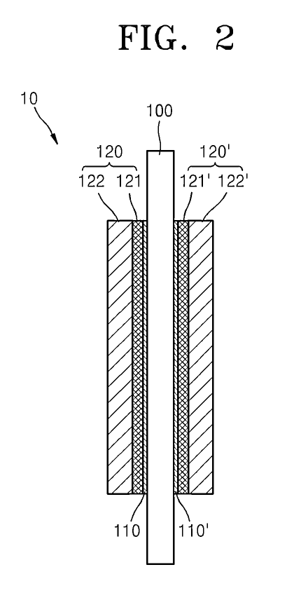

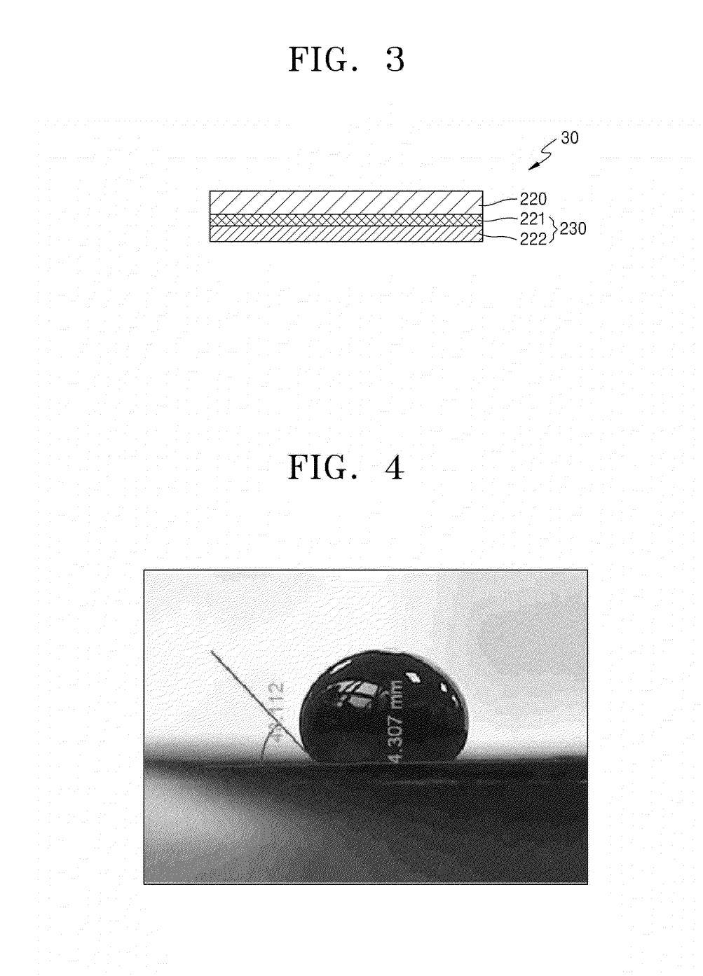

FIG. 3 is a cross-sectional schematic view of an electrode 30 of the MEA of FIG. 2.

Referring to FIG. 3, the electrode 30 includes a gas diffusion layer 230 having a microporous layer 221 disposed on an electrode support 222, and a catalyst layer 220 disposed on the gas diffusion layer 230.

The electrode 30 may be a cathode or an anode.

The electrode support 222 may be carbon paper or carbon cloth, but is not limited thereto. For example, the electrode support 22 may include an electrically conductive material such as a metal or a carbonaceous material.

A commercially available product may be used as the gas diffusion layer 230. In some embodiment, the microporous layer 221 may be coated on a commercially available carbon paper (electrode support).

A thickness of the gas diffusion layer 230 may be from about 200 μm to about 400 μm, in consideration gas diffusion and electrical resistance. The thickness of the gas diffusion layer 230 may be from about 100 μm to about 350 μm, and in some embodiments, from about 200 μm to about 350 μm.

The gas diffusion layer 230 may be hydrophobically treated to prevent flooding, which is caused by infiltration of a large amount of electrolyte into the catalyst layer of the fuel cell. In fuel cells, “flooding” refers to the infiltration of a large amount of electrolyte into the catalyst layer of a fuel cell to interrupt gas diffusion into the catalyst layer.

A material for hydrophobic treatment may be at least one selected from a 2,2-bistrifluoromethyl-4,5-difluoro-1,3-dioxoltetrafluoroethylene copolymer, polytetrafluoroethylene (PTFE), fluorinated ethylene propylene (FEP), polyvinylidene fluoride (PVdF), and Fluorosarf (available from Fluoro Technology Co.).

An amount of the material for the hydrophobic treatment may be from about 1 part to about 30 parts, about 5 to about 25 parts, about 5 to about 20 parts, about 20 to about 30 parts by weight based on 100 parts by weight of the carbonaceous material in the gas diffusion layer 230. When the amount of the material for hydrophobic treatment is within this range, fuel supply may be smooth even in an initial operation stage without flooding, so that the fuel cell may maintain high performance.

In general, the microporous layer 221 may contain conductive powder having a small diameter, for example, carbon powder, carbon black, acetylene black, active carbon, carbon fibers, fullerene, carbon nanotubes, carbon nanowires, carbon nanohorns, or carbon nanorings.

The catalyst layer 220 may be formed by coating the catalyst slurry on the gas diffusion layer 230 at a contact angle of about 143° or less, and in some embodiments, at a contact angle of about 120° to about 143°. When the contact angle of the catalyst layer 220 is within these ranges, wetting of the catalyst slurry on the gas diffusion layer 230 at a contact angle of about 120° to about 143°. When the contact angle of the catalyst slurry to the gas diffusion layer 230 in the coating of the catalyst slurry is within these ranges, wetting of the catalyst slurry on the gas diffusion layer 230 may be sufficient to form a catalyst layer 220 with a uniform thickness on the gas diffusion layer 230.

In the electrode 30 the volume of pores having a diameter of about 1 μm to about 5 μm may be about 0.15 mL/g or greater. Such a pore distribution in the electrode 30 including an increased amount of 1 μm to 5 μm -diameter pores is due to the formation of a porous structure in the catalyst layer 220 by the acid component used as an ionomer in the catalyst slurry.

According to another embodiment, a membrane-electrode assembly for a fuel cell includes: a cathode; an anode disposed opposite to the cathode; and an electrolyte membrane disposed between the cathode and the anode, at least one of the cathode and the anode being one of the electrodes according to the above-described embodiments.

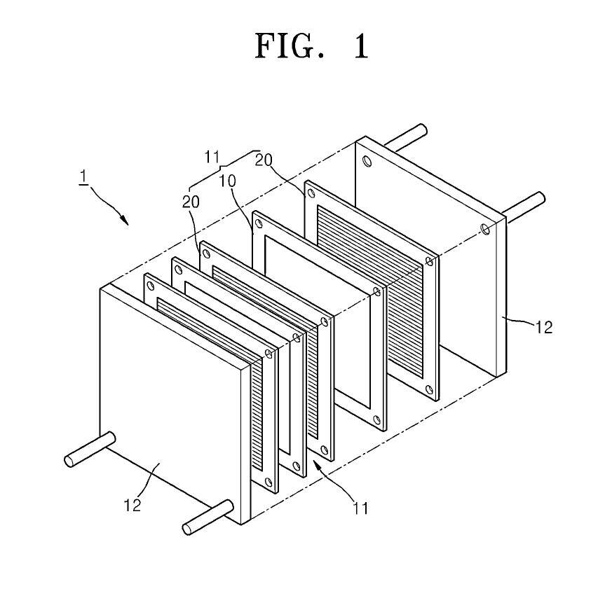

FIG. 2 is a schematic cross-sectional view of a membrane-electrode assembly (MEA) 10 of the fuel cell of FIG. 1.

Referring to FIG. 2, the MEA 10 includes an electrolyte membrane 100, catalyst layers 110 and 110′ disposed on lateral sides in a transverse direction of the electrolyte membrane 100, and microporous layers 121 and 121′ respectively stacked on the catalyst layers 110 and 110′, and gas diffusion layers 120 and 120′ respectively stacked on the catalyst layers 110 and 110′, the gas diffusion layer 120 and 120′ including microporous layers 121 and 121′ respectively stacked on the catalyst layers 110 and 110′, and electrode support 122 and 122′, respectively.

The electrolyte membrane 100 may be a polymer electrolyte membrane. The polymer electrolyte membrane is not particularly limited, and may an electrolyte membrane including at least one polymer selected from polybenzimidazole (PBI), cross-linked polybenzimidazole, polybenzoxazine, poly(2,5-benzimidazole (ABPBI), polyurethane, modified polytetrafluoroethylene (PTFE). Other polymer electrolyte membranes known in the art can also be used.

The electrolyte membrane 100 may be impregnated with inorganic phosphoric acid or organic phosphoric acid, and optionally with an acid that is not phosphoric acid. In some embodiments, the electrolyte membrane 100 may be impregnated with phosphoric acid-based material, for example, polyphosphoric acid, phosphonic acid (H₃PO₃), orthophosphoric acid(H₃PO₄), pyro phosphoric acid (H₂P₂O₇), triphosphoric acid (H₅P₃O₁₀), metaphosphoric acid, or a derivative thereof. A concentration of the phosphoric acid-based material is not specifically limited, for example, may be at least about 80 wt %, about 90 wt %, about 95 wt %, or about 98 wt %. For example, about 80 wt % to about 100 wt % of an aqueous phosphoric acid solution may be used.

In the MEA 10 of FIG. 2, the catalyst layers 110 and 110′, and the gas diffusion layers120 and 120′ including the microporous layers 121 and 121′ and the electrode support 122 and 122′ may be the same as those described above.

The electrode may have a proton-area specific resistance of about 0.23 ohm·cm² or less. The electrode may have improved ionic conductivity.

According to another embodiment, a fuel cell includes any of the MEAs according to the above-described embodiments.

The fuel cell may be a polymer electrolyte membrane fuel cell (PEMFC), a phosphoric acid fuel cell (PAFC), or a direct methanol fuel cell (DMFC).

FIG. 1 is a perspective exploded view of a fuel cell 1 according to an embodiment of the present disclosure.

Referring to FIG. 1, the fuel cell 1 includes two unit cells 11, which are supported by a pair of holders 12. Each unit cell 11 includes an MEA 10, and bipolar plates 20 disposed on lateral sides in a traverse direction of the MEA 10. Each bipolar plate 20 includes a conductive metal, carbon or the like, and operates as a current collector, while providing oxygen and fuel to the catalyst layers of the corresponding MEA 10.

According to another embodiment, a method of manufacturing an electrode for a fuel cell includes: preparing a catalyst slurry including a catalyst material, an acid component, a binder, and a solvent component having a viscosity of at least about 20 cps at about 20° C.; and coating the catalyst slurry on a gas diffusion layer having a microporous layer (MPL); and thermally treating the catalyst slurry coated gas diffusion layer to form a catalyst layer.

For example, the electrode for a fuel cell may be manufactured as follows.

A catalyst slurry for fuel cells including a catalyst material, an acid component, and a binder, and a solvent component having a viscosity of at least about 20 cps at about 20° C. may be prepared. The catalyst slurry may be prepared in about 5 minutes to about 1 hour via pre-doping with an acid component catalyst slurry preparation.

The solvent component may be at least one selected from diethylene glycol (DEG), propylene glycol (PG), dipropylene glycol (DPG), 1,3-butylene glycol, and dihydroterpineol (DHT).

The binder may be at least one selected from a polybenzoxazine, a fluorinated polymer, a benzimidazole polymer, a polyimide, a polyetherimide, a polyphenylenesulfide, a polysulfone, a polyethersulfone, a polyetherketone, a polyether-etherketone, and a polyphenylquinoxaline. The types and amounts of the binder may be the same as those described in previous embodiments.

The acid component may be at least one selected from phosphoric acid, polyphosphoric acid, sulfuric acid, nitric acid, perchloric acid organic phosphonic acid, inorganic phosphonic acid, and trifluoromethane sulfonic acid.

In the catalyst slurry for a fuel cell, a weight ratio of the catalyst metal to the solvent may be from about 1:3 to about 1:25, and in some other embodiments, from about 1:5 to about 1:19. When the weight ratio of the catalyst metal to the solvent is within these ranges, the catalyst slurry may maintain an appropriate viscosity and a uniform composition.

In the catalyst slurry for a fuel cell, a weight ratio of the catalyst metal to the acid component in the catalyst slurry may be from about 1:0.1 to about 1:10, and in some other embodiments, from about 1:0.4 to about 1:4.3. When the weight ratio of the catalyst metal to the acid component is within these ranges, the fuel cell may have improved performance.

The catalyst material may include a support and a catalytic metal loaded on the support. The types and amounts of the catalyst metal and the support may be the same as those described above.

The binder may be the same as those described above.

The gas diffusion layer may be hydrophobically treated. A material for hydrophobic treatment may be at least one selected from a 2,2-bistrifluoromethyl-4,5-difluoro-1,3-dioxoltetrafluoroethylene copolymer, polytetrafluoroethylene (PTFE), fluorinated ethylene propylene (FEP), polyvinylidene fluoride (PVdF), and Fluorosarf (available from Fluoro Technology Co.). An amount of the material for hydrophobic treatment may be the same as that described hereinabove.

Next, the catalyst slurry may be coated on a gas diffusion layer coated with a microporous layer (MPL), for example, using coating or printing. Any of coating or printing methods available in the field of fuel cell may be used.

The catalyst slurry may be coated on the gas diffusion layer at a contact angle of about 143° or less, and in some embodiments, at a contact angle of about 120° to about 143°. When the contact angle of the catalyst slurry to the gas diffusion layer in the coating of the catalyst slurry is within these ranges, wetting of the catalyst slurry on the gas diffusion layer may be sufficient to form a catalyst layer with a uniform thickness on the gas diffusion layer. Next, the coated electrode may be thermally treated at about 60° C. to about 150° C. for about 1 hour to about 7 hours to obtain a catalyst layer on the gas diffusion layer, thereby manufacturing the electrode.

In the electrode the volume of pores having a diameter of about 1 μm to about 5 μm may be about 0.15 mL/g or greater. Such a pore distribution in the electrode including an increased amount of 1 μm to 5 μm -diameter pores is due to the formation of a porous structure in the catalyst layer 220 by the acid component as an ionomer in the catalyst slurry.

In some embodiments, the electrode manufacturing method does not involve additional processes after the manufacturing of the electrode, such as impregnating the electrode with phosphoric acid and drying the electrode, and thus may reduce the process time.

A polymer electrolyte membrane impregnated with about 80 wt % to about 100 wt % aqueous phosphoric acid may be disposed between the electrodes, i.e., the cathode and the anode, thereby manufacturing an MEA.

The embodiments will now be described with reference to the following examples. These examples are for illustrative purposes only and are not intended to limit the scope of the disclosure.

### EXAMPLES

### Preparation of Catalyst Slurry

### Example 1

### Preparation of Catalyst Slurry

200 g of a 85 wt % phosphoric acid was added to 2 g of a compound (4FPh2AP) represented by Formula 1, and mixed together at about 80° C. for about 1 hour to obtain a solution of 4FPh2AP in phosphoric acid, which was then thermally treated at about 160° C. for polymerization.

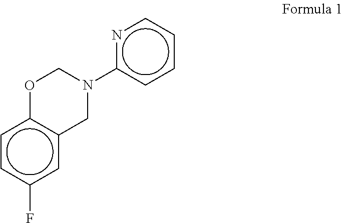

A resulting polymerization product was centrifuged to remove phosphoric acid, followed by rinsing with water and adding water thereto to obtain an aqueous binder solution including about 5 wt % of polybenzoxazine particles.

A supported catalyst of PtCo loaded on carbon (PtCo/C) (available from Tanaka Precious Metals, Japan), dipropylene glycol (DPG) having a viscosity of about 107 cps at 20° C., a phosphoric acid, and the aqueous polybenzoxazine binder were mixed in a weight ratio of about 1:9:1.9:0.2, and then mixed at room temperature for about 10 minutes to prepare a catalyst slurry.

### Example 2

### Preparation of Catalyst Slurry

A catalyst slurry was prepared in the same manner as in Example 1, except that a supported catalyst of PtCo loaded on carbon (PtCo/C) (available from Tanaka Precious Metals, Japan), dipropylene glycol (DPG) having a viscosity of about 107 cps at 20° C., a phosphoric acid, and the aqueous binder were mixed in a weight ratio of 1:5:4.3:0.2, instead of the weight ratio of about 1:9:1.9:0.2 in Example 1, and then mixed at room temperature for about 10 minutes to prepare a catalyst slurry.

### Example 3

### Preparation of Catalyst Slurry

A catalyst slurry was prepared in the same manner as in Example 1, except that a supported catalyst of PtCo loaded on carbon (PtCo/C) (available from Tanaka Precious Metals, Japan), dipropylene glycol (DPG) having a viscosity of about 107 cps at 20° C., a phosphoric acid, and the aqueous polybenzoxazine binder were mixed in a weight ratio of 1:5:0.4:0.2, instead of the weight ratio of about 1:9:1.9:0.2 in Example 1, and then mixed at room temperature for about 10 minutes to prepare a catalyst slurry.

### Example 4

### Preparation of Catalyst Slurry

A catalyst slurry was prepared in the same manner as in Example 1, except that a supported catalyst of PtCo loaded on carbon (PtCo/C) (available from Tanaka Precious Metals, Japan), dipropylene glycol (DPG) having a viscosity of about 107 cps at 20° C., a phosphoric acid, and the aqueous polybenzoxazine binder were mixed in a weight ratio of 1:19:4.3:0.2, instead of the weight ratio of about 1:9:1.9:0.2 in Example 1, and then mixed at room temperature for about 10 minutes to prepare a catalyst slurry.

### Example 5

### Preparation of Catalyst Slurry

A catalyst slurry was prepared in the same manner as in Example 1, except that a supported catalyst of PtCo loaded on carbon (PtCo/C) (available from Tanaka Precious Metals, Japan), dipropylene glycol (DPG) having a viscosity of about 107 cps at 20° C., a phosphoric acid, and the aqueous polybenzoxazine binder were mixed in a weight ratio of 1:19:0.4:0.2, instead of the weight ratio of about 1:9:1.9:0.2 in Example 1, and then mixed at room temperature for about 10 minutes to prepare a catalyst slurry.

### Comparative Example 1

### Preparation of Catalyst Slurry

A catalyst slurry was prepared in the same manner as in Example 1, except that a supported catalyst of PtCo loaded on carbon (PtCo/C) (available from Tanaka Precious Metals, Japan), water having a viscosity of about 1.002 cps at 20° C., instead of dipropylene glycol (DPG) having a viscosity of about 107 cps at 20° C. used in Example 1, a phosphoric acid, and the aqueous polybenzoxazine binder were mixed in a weight ratio of 1:9:1.9:0.2, and then mixed at room temperature for about 10 minutes to prepare a catalyst slurry.

### Comparative Example 2

### Preparation of Catalyst Slurry

A catalyst slurry was prepared in the same manner as in Example 1, except that a supported catalyst of PtCo loaded on carbon (PtCo/C) (available from Tanaka Precious Metals, Japan), NMP having a viscosity of about 1.7 cps at 20° C., instead of dipropylene glycol (DPG) having a viscosity of about 107 cps at 20° C. used in Example 1, a phosphoric acid, and the aqueous polybenzoxazine binder were mixed in a weight ratio of 1:9:1.9:0.2, and then mixed at room temperature for about 10 minutes to prepare a catalyst slurry.

### Comparative Example 3

### Preparation of Catalyst Slurry

A catalyst slurry was prepared in the same manner as in Example 1, except that a supported catalyst of PtCo loaded on carbon (PtCo/C) (available from Tanaka Precious Metals, Japan), ethylene glycol (EG) having a viscosity of about 16.5 cps at 20° C., instead of dipropylene glycol (DPG) having a viscosity of about 107 cps at 20° C. used in Example 1, a phosphoric acid, and the aqueous polybenzoxazine binder were mixed in a weight ratio of 1:9:1.9:0.2, and then mixed at room temperature for about 10 minutes to prepare a catalyst slurry.

### Comparative Example 4

### Preparation of Catalyst Slurry

A catalyst slurry was prepared in the same manner as in Example 1, except that a supported catalyst of PtCo loaded on carbon (PtCo/C) (available from Tanaka Precious Metals, Japan), NMP having a viscosity of about 1.7 cps at 20° C., and the aqueous polybenzoxazine binder were mixed in a weight ratio of 1:9:0.2, instead of mixing a supported catalyst of PtCo loaded on carbon (PtCo/C) (available from Tanaka Precious Metals, Japan), dipropylene glycol (DPG) having a viscosity of about 107 cps at 20° C., a phosphoric acid, and the aqueous polybenzoxazine binder in a weight ratio of 1:9:1.9:0.2 in Example 1, and then mixed at room temperature for about 10 minutes to prepare a catalyst slurry.

Manufacture of membrane-electrode assembly

### Example 6

### Manufacture of MEA

After the catalyst slurry of Example 1 was coated on a gas diffusion layer on carbon paper by using a wire bar, the gas diffusion layer having a microporous layer (MPL) hydrophobically treated with 23 wt % of polytetrafluoroethylene, the resulting structure was thermally treated at about 80° C. for about 1 hour, at about 120° C. for about 30 minutes, and then at about 150° C. for about 10 minutes to form a catalyst layer on the gas diffusion layer, thereby obtaining a cathode having a thickness of about 380 μm.

An anode was manufactured as follows.

A supported catalyst of PtRu loaded on carbon (PtRu/C) (available from Tanaka Precious Metals, Japan), NMP having a viscosity of about 1.7 cps at 20° C., and the aqueous polybenzoxazine binder prepared in Example 1 were mixed in a weight ratio of about 1:5.5:0.2, and then mixed at room temperature for about 10 minutes to prepare a catalyst slurry.

After the catalyst slurry was coated on a gas diffusion layer on carbon paper by using a wire bar, the gas diffusion layer having a microporous layer (MPL) hydrophobic treated with 23 wt % of polytetrafluoroethylene, the resulting structure was thermally treated at about 80° C. for about 1 hour, at about 120° C. for about 30 minutes, and then at about 150° C. for about 10 minutes, followed by impregnating phosphoric acid into surface of the resultant, thereby manufacturing the anode.

The cathode and the anode were cut to a size of about 2.8 cm×2.8 cm. A polybenzimidazole-polybenzoxazine membrane impregnated with 85 wt % of phosphoric acid and having a thickness of about 50 μm to about 80 μm was disposed between the cathode and the anode to manufacture a membrane-electrode assembly (MEA).

### Examples 7-10

### Manufacture of MEA

MEAs were manufactured in the same manner as in Example 6, except that after each of the catalyst slurries of Examples 2 to 5, instead of the catalyst slurry of Example 1, was coated on a gas diffusion layer on carbon paper by using a wire bar, the gas diffusion layer having a microporous layer (MPL) hydrophobic treated with 23 wt % of polytetrafluoroethylene, the resulting structure was thermally treated at about 80° C. for about 1 hour, at about 120° C. for about 30 minutes, and then at about 150° C. for about 10 minutes to form a catalyst layer on the gas diffusion layer, thereby obtaining a cathode having a thickness of about 380 μm.

### Comparative Examples 5-8

### Manufacture of MEA

MEAs were manufactured in the same manner as in Example 6, except that after each of the catalyst slurries of Comparative Examples 1 to 4, instead of the catalyst slurry of Example 1, was coated on a gas diffusion layer on carbon paper by using a wire bar, the gas diffusion layer having a microporous layer (MPL) hydrophobic treated with 23 wt % of polytetrafluoroethylene, the resulting structure was thermally treated at about 80° C. for about 1 hour, at about 120° C. for about 30 minutes, and then at about 150° C. for about 10 minutes to form a catalyst layer on the gas diffusion layer, thereby obtaining a cathode having a thickness of about 380 μm.

### Comparative Example 9

### Manufacture of MEA

After the catalyst slurry of Comparative Example 4 was coated on a gas diffusion layer on carbon paper by using a wire bar, the gas diffusion layer having a microporous layer (MPL) hydrophobically treated with 23 wt % of polytetrafluoroethylene, the resulting structure was thermally treated at about 80° C. for about 1 hour, at about 120° C. for about 30 minutes, and then at about 150° C. for about 10 minutes to form a catalyst layer on the gas diffusion layer, thereby obtaining a cathode having a thickness of about 380 μm. The catalyst was impregnated with phosphoric acid and then dried. The amount of phosphoric acid impregnated into the cathode was about 6.5 mg/cm².

An anode was manufactured as follows.

A supported catalyst of PtRu loaded on carbon (PtRu/C) (available from Tanaka Precious Metals, Japan), NMP having a viscosity of about 1.7 cps at 20° C., and the aqueous polybenzoxazine binder prepared in Example 1 were mixed in a weight ratio of about 1:5.5:0.2, and then mixed at room temperature for about 10 minutes to prepare a catalyst slurry. After the catalyst slurry was coated on a gas diffusion layer on carbon paper by using a wire bar, the gas diffusion layer having a microporous layer (MPL) hydrophobic treated with 23 wt % of polytetrafluoroethylene, the resulting structure was thermally treated at about 80° C. for about 1 hour, at about 120° C. for about 30 minutes, and then at about 150° C. for about 10 minutes, followed by impregnating phosphoric acid into surface of the resultant, thereby manufacturing the anode.

A polybenzimidazole-polybenzoxazine membrane impregnated with 85 wt % of phosphoric acid and having a thickness of about 50 μm to about 80 μm was disposed between the cathode and the anode to manufacture an membrane-electrode assembly (MEA).

The compositions of the catalyst slurries of Examples 1 to 5 and Comparative Examples 1 to 4 were summarized in Table 1.

TABLE 1

| | | Solvent component/ | Acid component as | Weight ratio of |
|---|---|---|---|---|
| | | Viscosity at 20° C. | ionomer/Type of | catalyst:solvent:phosphoric |
| Example | Catalyst | (cps) | impregnation | acid |
| Example 1 | PtCo/C | DPG/107 | Phosphoric acid/ | 1:9:1.9 |
| | | | Pre-impregnation | |
| Example 2 | PtCo/C | DPG/107 | Phosphoric acid/ | 1:5:4.3 |
| | | | Pre-impregnation | |
| Example 3 | PtCo/C | DPG/107 | Phosphoric acid/ | 1:5:0.4 |
| | | | Pre-impregnation | |
| Example 4 | PtCo/C | DPG/107 | Phosphoric acid/ | 1:19:4.3 |
| | | | Pre-impregnation | |
| Example 5 | PtCo/C | DPG/107 | Phosphoric acid/ | 1:19:0.4 |
| | | | Pre-impregnation | |
| Comparative | PtCo/C | H₂O/1.002 | Phosphoric acid/ | 1:9:1.9 |
| Example 1 | | | Pre-impregnation | |
| Comparative | PtCo/C | NMP/1.7 | Phosphoric acid/ | 1:9:1.9 |
| Example 2 | | | Pre-impregnation | |
| Comparative | PtCo/C | EG/16.5 | Phosphoric acid/ | 1:9:1.9 |
| Example 3 | | | Pre-impregnation | |
| Comparative | PtCo/C | NMP/1.7 | None/Post- | 1:9:0 |
| Example 4 | | | impregnation | |

### Evaluation Example 1

### Contact Angle of Catalyst Slurry

After dropping each of the catalyst slurries of Examples 1 to 5 and Comparative Examples 1 to 3 onto the gas diffusion layer coated with the microporous layer (MPL), a contact angle of the catalyst slurry to a surface of the gas diffusion layer was measured using a contact angle measuring device. The results are shown in Table 2 and FIG. 4.

TABLE 2

| Example | Contact angle (°) |
|---|---|
| Example 1 | 132 |
| Example 2 | 143 |
| Example 3 | 140 |
| Example 4 | 130 |
| Example 5 | 128 |
| Comparative | 150 |
| Example 1 | |
| Comparative | 129 |
| Example 2 | |
| Comparative | 145 |
| Example 3 | |

Referring to Table 2 and FIG. 4, the catalyst slurries of Examples 1 to 5 were found to have a contact angle of about 128° to about 143°, while the catalyst slurries of Comparative Examples 1 and 3 had a contact angle over 143°.

### Evaluation Example 2

### Storage Stability of Catalyst Slurry

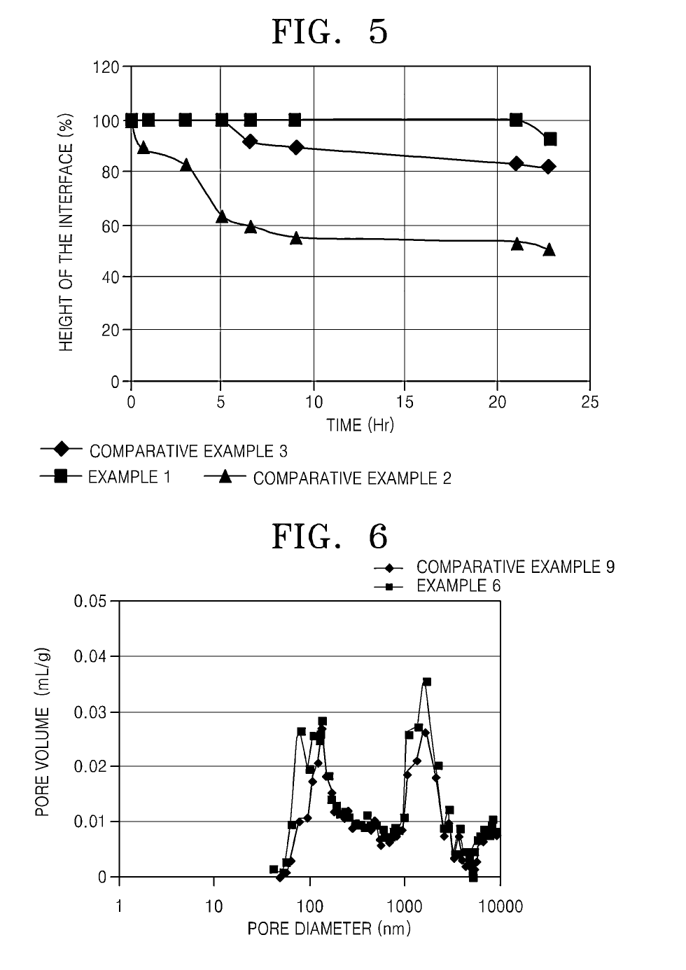

An accelerated test for stability of the catalyst slurries of Example 1 and Comparative Examples 2 and 3 were performed as follows. Each of the catalyst slurries of Example 1 and Comparative Examples 2 and 3 was diluted with a solvent to one third (⅓), and then put in vials, which were then stored for about 22 hours and 45 minutes. An interface height of the catalyst slurry was visually observed after the storage. The results are shown in FIG. 5.

Referring to FIG. 5, the catalyst slurry of Example 1 was found to have a reduced interface height after about 21 hours of storage, while the catalyst slurries of Comparative Examples 2 and 3 had a reduced height after about 6 to 7 hours of storage. The longer it takes for the interface height to decrease, the better the storage stability of the catalyst slurry.

### Evaluation Example 3

### Pore Characteristics of Electrode

Pore size distributions of the cathodes manufactured in Example 6 and Comparative Example 9 were measured using a mercury (Hg) porosimeter. The results are shown in FIG. 6. A total specific pore volume of each electrode, and a specific pore volume of pores having a diameter of about 1 μm to about 5 μm are shown in Table 3.

TABLE 3

| | | Specific pore |
|---|---|---|
| | Total specific pore | volume of 1 μm- to 5 μm- |
| Example | volume (SV_{T}) (mL/g) | diameter pores (SV_{T}) (mL/g) |
| Example 6 | 1.46 | 0.16 |
| Comparative | 1.17 | 0.12 |
| Example 9 | | |

Referring to Table 3 and FIG. 6, the electrode of Example 6 was found to have a larger specific pore volume of 1 μm to 5 μm -diameter pores than that of the electrode of Comparative Example 9.

### Evaluation Example 4

### Evaluation of Cell Performance

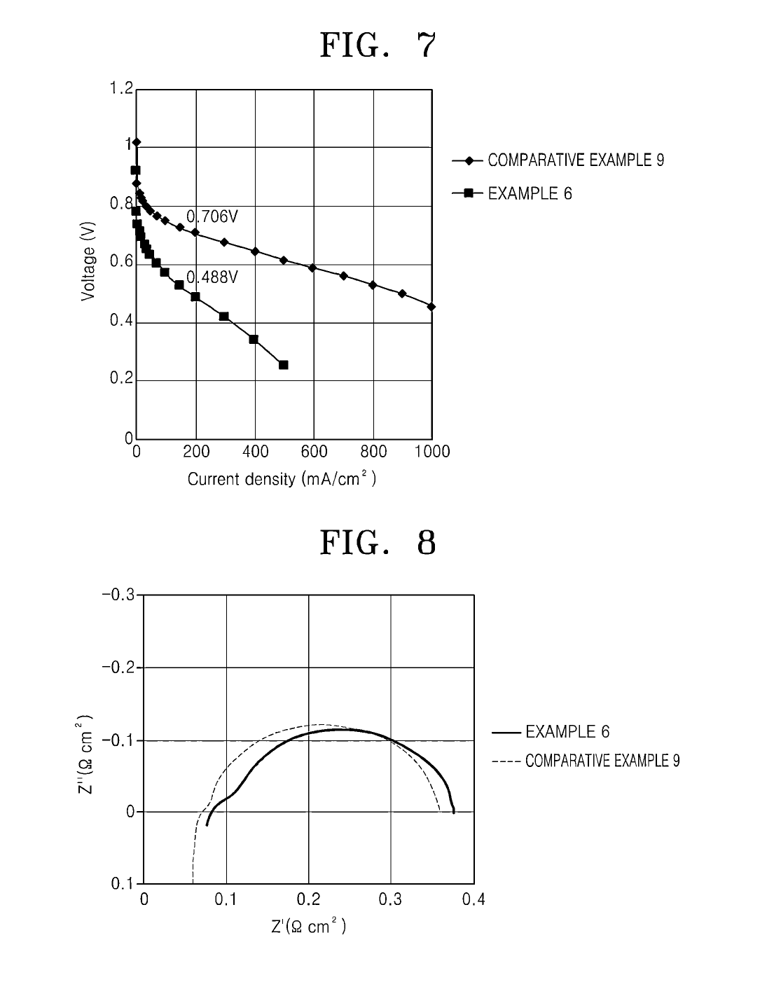

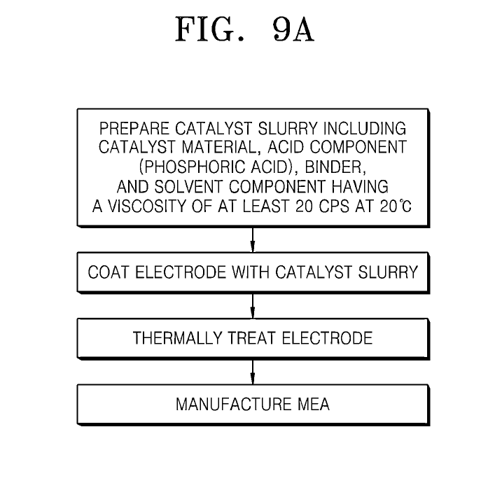

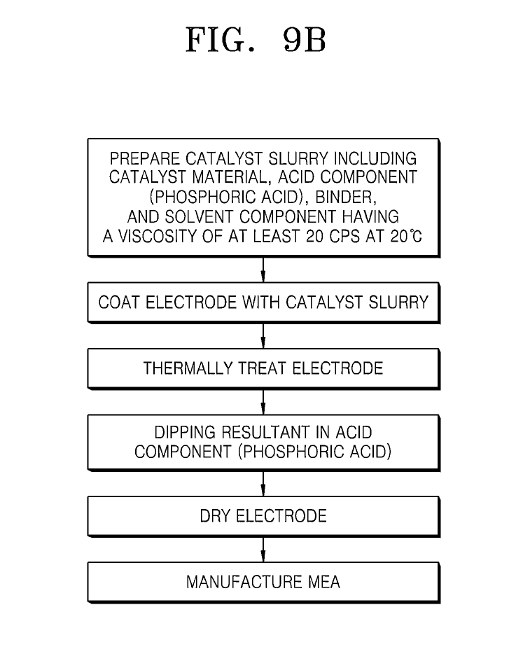

Cell performance at a current density of about 0.2 A/cm² was measured using the MEAs of Example 6 and Comparative Example 9. The results are shown in Table 4 and FIG. 7.

TABLE 4

| | Open-circuit voltage |
|---|---|
| Example | at 0.2 A/cm² current density [V] |
| Example 6 | 0.699 V |
| Comparative Example 9 | 0.488 V |

Referring to Table 4 and FIG. 7, the MEA of Example 6 was found to have a higher open-circuit voltage than that of the MEA of Comparative Example 9 at a current density of 0.2 A/cm².

### Evaluation Example 5

### Cell Impedance Evaluation

AC impedances of the MEAs of Example 6 and Comparative Example 9 were measured at a current density of 0.2 A/cm². The results are shown in FIG. 8. In FIG. 8, Z′ denotes resistance, and Z″ denotes impedance.

In FIG. 8, the position and size of a half circle determine the impedance of each MEA. The first x-intercept (on the X-axis or horizontal axis) of a half circle represents a resistance of the electrode membrane. A difference between the first x-intercept and the second x-intercept represents an electrode resistance, which may be divided into a proton-transfer resistance and a charge-transfer resistance in the electrode using a single-circuit model.

Referring to FIG. 8, the cathode of the MEA of Example 6 was found to have a proton-area specific resistance of about 0.227 ohm·cm², while the cathode of the MEA of Comparative Example 9 had a proton-area specific resistance of about 0.239 ohm·cm².

These results indicate that the cathode of the MEA of Example 6 had a lower proton-transfer resistance than that of the cathode of the MEA of Comparative Example 9.

As described above, according to the one or more of the above embodiments of the present disclosure, an electrode for a fuel cell with uniform composition and improved cell performance may be manufactured using a catalyst slurry including a catalyst material, an acid component, a binder, and a solvent component having a viscosity of at least about 20 cps at about 20° C. An MEA and a fuel cell may be manufactured using the electrode. A method of manufacturing the electrode may reduce process time.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A catalyst slurry for a fuel cell, the catalyst slurry comprising a catalyst material, an acid component, a binder, and a solvent component having a viscosity of at least about 20 cps at about 20° C.

2. The catalyst slurry of claim 1, wherein the solvent component has a viscosity of about 20 cps to about 1500 cps at about 20° C.

3. The catalyst slurry of claim 1, wherein the solvent component is at least one selected from diethylene glycol, propylene glycol, dipropylene glycol, 1,3-butylene glycol, and dihydroterpineol.

4. The catalyst slurry of claim 1, wherein the acid component is at least one selected from phosphoric acid, polyphosphoric acid, phosphorous acid, sulfuric acid, nitric acid, perchloric acid, phosphonic acid, and trifluoromethane sulfonic acid.

5. The catalyst slurry of claim 1, wherein the catalyst material comprises a support and a catalytic metal loaded on the support.

6. The catalyst slurry of claim 1, wherein a weight ratio of the catalyst metal to the solvent in the catalyst slurry is from about 1:3 to about 1:25.

7. The catalyst slurry of claim 1, wherein a weight ratio of the catalyst metal to the acid component in the catalyst slurry is from about 1:0.1 to about 1:10.

8. An electrode for a fuel cell, the electrode comprising:
a gas diffusion layer having a microporous layer disposed on an electrode support; and
a catalyst layer disposed on the gas diffusion layer, the catalyst layer being formed using the catalyst slurry of claim 1.

9. The electrode of claim 8, wherein the gas diffusion layer is hydrophobically treated.

10. The electrode of claim 8, wherein the catalyst layer is formed by coating the catalyst slurry on the gas diffusion layer at a contact angle of about 143° or less.

11. The electrode of claim 8, wherein a volume of pores having a pore diameter of about 1 μm to about 5 μm in the electrode is about 0.15 mL/g or greater.

12. A membrane-electrode assembly for a fuel cell, the membrane-electrode assembly comprising:
a cathode;
an anode disposed opposite to the cathode; and
an electrolyte membrane disposed between the cathode and the anode,
wherein at least one of the cathode and the anode is the electrode of claim 8.

13. The membrane-electrode assembly of claim 12, wherein the electrode has a proton-area specific resistance of about 0.23 ohm·cm² or less.

14. A fuel cell comprising the membrane-electrode assembly of claim 12.

15. A method of manufacturing an electrode for a fuel cell, the method comprising:
preparing a catalyst slurry comprising a catalyst material, an acid component, a binder, and a solvent component having a viscosity of at least about 20 cps at about 20° C.; and
coating the catalyst slurry on a gas diffusion layer having a microporous layer; and
thermally treating the catalyst slurry coated gas diffusion layer to form a catalyst layer on the gas diffusion layer.

16. The method of claim 15, wherein the solvent component is at least one selected from diethylene glycol, propylene glycol, dipropylene glycol, 1,3-butylene glycol, and dihydroterpineol.

17. The method of claim 15, wherein the acid component is at least one selected from phosphoric acid, polyphosphoric acid, sulfuric acid, nitric acid, perchloric acid, organic phosphonic acid, inorganic phosphonic acid, and trifluoromethane sulfonic acid.

18. The method of claim 15, wherein a weight ratio of the catalyst metal to the solvent in the catalyst slurry is from about 1:3 to about 1:25.

19. The method of claim 15, wherein a weight ratio of the catalyst metal to the acid component in the catalyst slurry is from about 1:0.1 to about 1:10.

20. The method of claim 15, wherein, in the forming of the catalyst layer, the catalyst slurry is coated on the gas diffusion layer at a contact angle of about 143° or less.
